(19) United States
(12) Patent Application Publication
(10) Pub. No.: US 2021/0020097 A1
(43) Pub. Date: Jan. 21, 2021

(54) DISPLAY DEVICE

(71) Applicant: Mitsubishi Electric Corporation, Tokyo (JP)

(72) Inventors: Hirokazu TAGUCHI, Tokyo (JP); Hideki NARITA, Tokyo (JP); Yoshinori ASAMURA, Tokyo (JP)

(73) Assignee: Mitsubishi Electric Corporation, Tokyo (JP)

(21) Appl. No.: 16/981,610

(22) PCT Filed: Jun. 1, 2018
(86) PCT No.: PCT/JP2018/021148

§ 371 Date: Sep. 16, 2020

(51) Int. Cl. G09G 3/32

(52) U.S. Cl. CPC G09G 3/32; G09G 2360/145; G09G 2320/0233; G09G 2300/023; G09G 2320/0626; G09G 2360/16; G09G 2320/0673

(57) ABSTRACT

A display device of the present invention includes a first display unit, a second display unit, a lighting time storage configured to store first cumulative lighting times of the of first light emitting elements of the first display unit, a light receiving unit configured to measure luminance of the second light emitting elements, a luminance transition storage configured to associate the luminance of the second light emitting elements with a second cumulative lighting time and store thereof, and a luminance corrector configured to correct luminance of the first light emitting elements based on the first cumulative lighting time, the luminance of the second light emitting elements, and the second cumulative lighting time.

### TECHNICAL FIELD

The present invention relates to a display device including a display unit having light emitting elements.

### BACKGROUND ART

LED display devices that display images with a plurality of light emitting diodes (LEDs) are used in many applications such as outdoor and indoor advertisement display due to technological development and cost reduction of LEDs. Specifically, a conventional LED display device has been mainly used for displaying moving images of nature images and animated movies. In recent years, however, the use of such a display device in a conference room or for monitoring applications indoors has become prevalent as the image quality has been maintained even with a short viewing distance along with narrowing of the pixel pitch. Personal-computer based images being almost still images are displayed in many cases in the monitoring applications.

The methods of adjusting the brightness of the image displayed by the LED display device include a method of adjusting the duty ratio of Pulse Width Modulation (PWM) controlled LEDs and a method of adjusting the current value for driving the LEDs. The reduction in the brightness of the image by adjusting the duty ratio leads to reduction in the gradation that can be displayed. Therefore, the method of adjusting the LED drive current value is preferable to adopt in order to maintain good image quality even when displaying a low gradation image.

Further, the luminance of LEDs decreases as the cumulative lighting time increases; therefore, the cumulative lighting time of each LED, moreover, the luminance reduction rate of each LED, varies depending on the content of the displayed image. As a result, variation in luminance and chromaticity of pixels occurs as the cumulative lighting time increases.

In order to reduce such luminance variation and chromaticity variation, for example, Patent Document 1 proposes a technique for correcting the luminance of the LED display surface, that is, the luminance of the surface displaying an image toward an observer, using a reference LED. The reference LED is mounted on the surface opposite to the surface on which a plurality of LEDs that constituting the LED display surface, out of the two surfaces included in the circuit board built into the LED display device, and is driven in a same manner as a plurality of LEDs constituting the LED display surface.

### PRIOR ART DOCUMENTS5

### Patent Documents

[Patent Document 1] Japanese Patent Application Laid-Open No. 2014-102484

### SUMMARY

### Problem to be Solved by the Invention

The reference LED, which is driven in the same manner as the plurality of LEDs on the LED display surface side, deteriorates like as the LEDs on the display surface side deteriorate. In the conventional LED display device, the luminance of the reference LED is detected by an optical sensor to measure the luminance reduction rate, and the luminance of the LEDs on the display surface side can be corrected based on the luminance reduction rate. The technology allows the LED display device to correct the luminance and chromaticity variations on the LED display surface due to the varied lighting times of the LEDs.

However, as disclosed in Patent Document 1, conventionally, only one reference LED is mounted for one circuit board on which a plurality of LEDs are mounted on the display surface side, if the drive current value of the LEDs is changed in order to adjust the brightness of the LEDs on the display surface during operation of the LED display device, the correction of the variations of luminance and chromaticity based on the luminance reduction rate of one reference LED is difficult because the transition of the luminance reduction in LEDs depends on the drive current value and the variations in the luminance and chromaticity of the LED display surface occur due to, in addition to the difference in the cumulative lighting times of the LEDs, due to changes in the drive current value.

The present invention has been made to solve the above problem, and an object of the present invention is to provide a display device having an improved effect of suppressing variations in luminance and chromaticity of a display unit.

### Means to Solve the Problem

According to the present invention, a display device includes a first display unit having a plurality of first light emitting elements and configured to display an image, a second display unit having a plurality of second light emitting elements whose time transition on luminance is equal to that of the plurality of first light emitting elements, a lighting time storage configured to store respective first cumulative lighting times of the plurality of first light emitting elements, a light receiving unit configured to measure luminance of the plurality of second light emitting elements, a luminance transition storage configured to associate the luminance of the plurality of second light emitting elements measured by the light receiving unit with a second cumulative lighting time of the plurality of second light emitting elements and store thereof, and a luminance corrector configured to correct luminance of the plurality of first light emitting elements based on the first cumulative lighting time stored in the lighting time storage and the luminance of the plurality of second light emitting elements and the second cumulative lighting time stored in the luminance transition storage, in which the plurality of first light emitting elements are controlled to be on based on the image to be displayed, the plurality of second light emitting elements are controlled to be always on, and the luminance corrector is configured to read out the luminance at the second cumulative lighting time corresponding to the first cumulative lighting time of each of the plurality of first light emitting elements stored in the lighting time storage from the luminance transition storage to calculate luminance reduction rates of the second light emitting elements, set the luminance reduction rates of the second light emitting elements as luminance reduction rates of the plurality of first light emitting elements, and correct the luminance of the plurality of respective first light emitting elements so as to match a greatest maximum luminance reduction rate among the luminance reduction rates of the plurality of first light emitting elements.

### Effects of the Invention

According to the display device of the present invention, a display device having an improved effect of suppressing variations in luminance and chromaticity of a display unit is obtained.

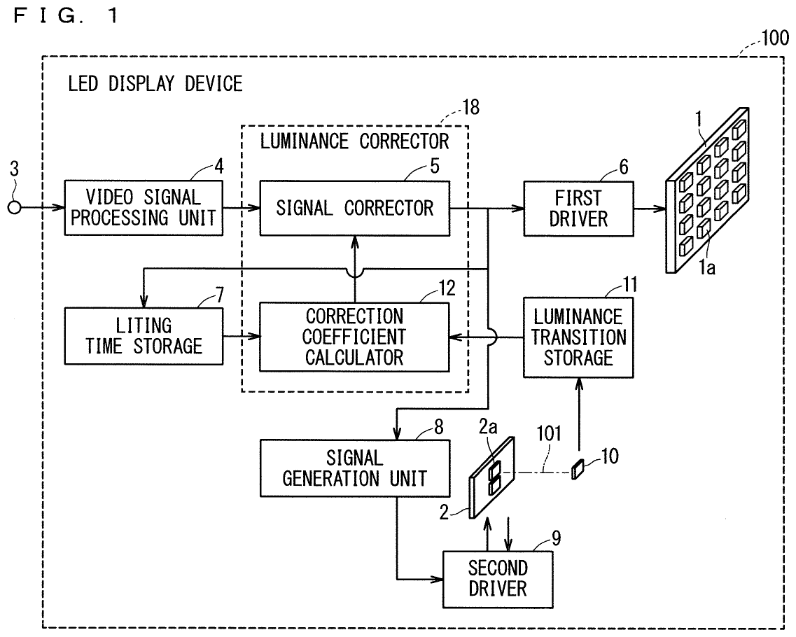

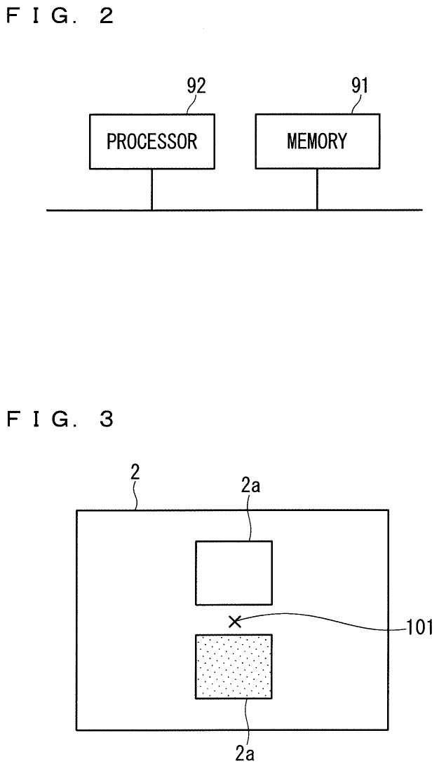

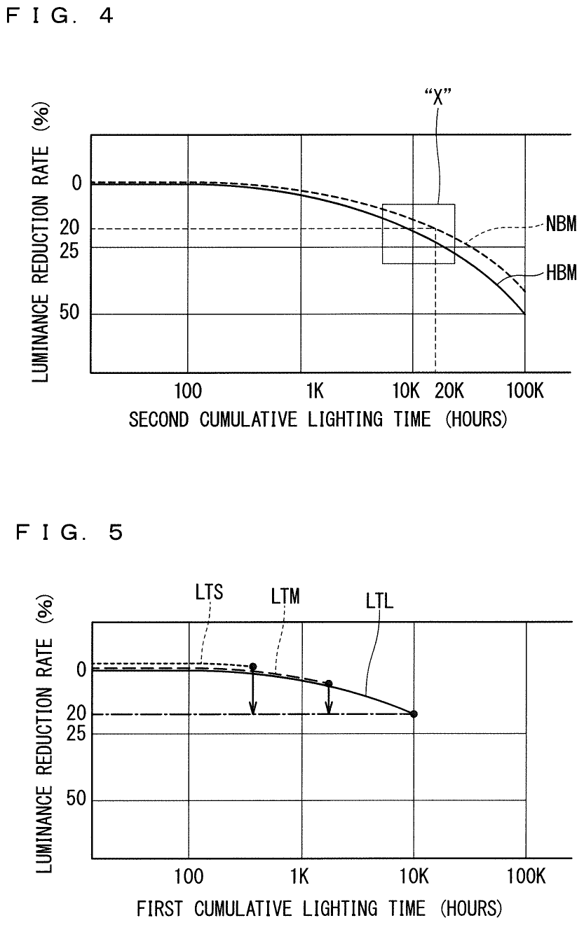

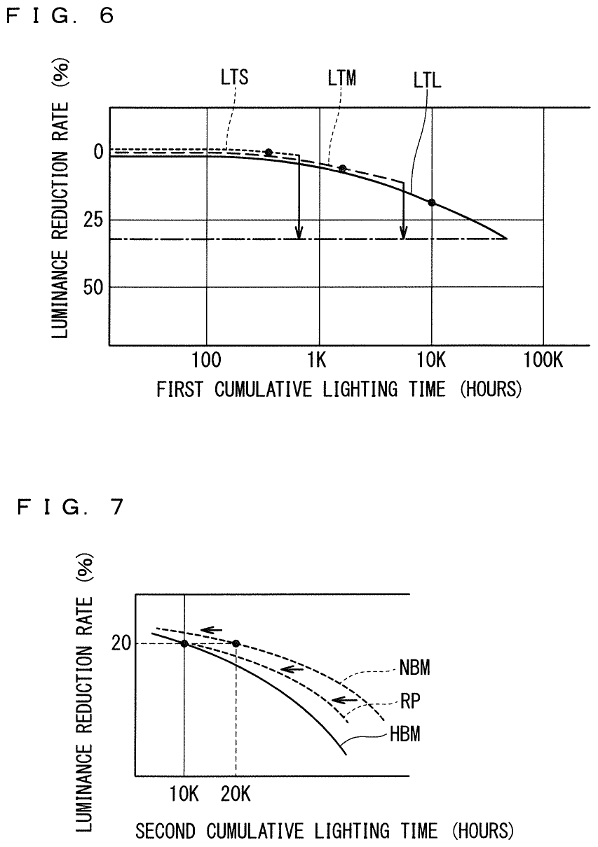

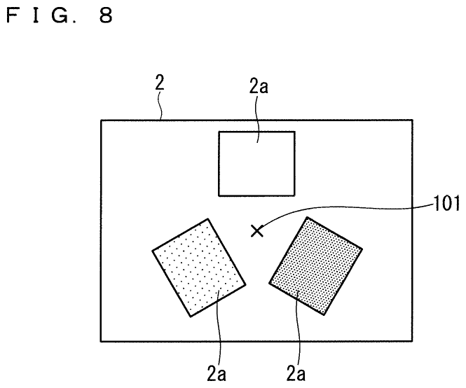

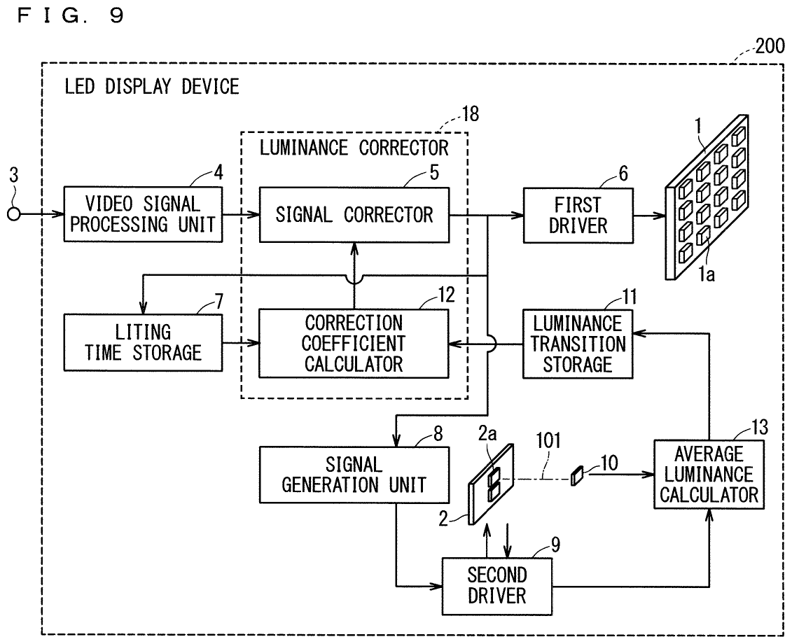

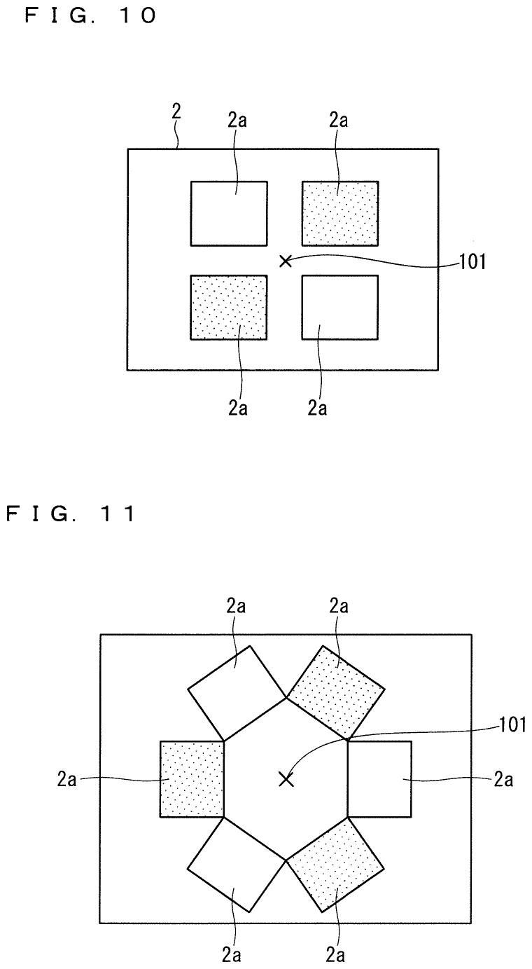

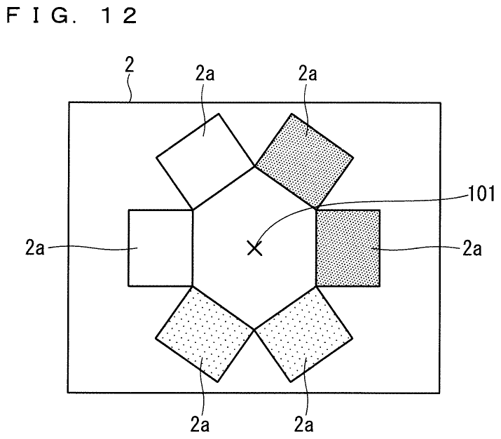

### BRIEF DESCRIPTION OF DRAWINGS

[FIG. 1] A block diagram illustrating a configuration of an LED display device of Embodiment 1 according to the present invention.

[FIG. 2] A block diagram illustrating a hardware configuration of the LED display device of Embodiment 1 according to the present invention.

[FIG. 3] A schematic plan view of a second LED display unit of the LED display device of Embodiment 1 according to the present invention as viewed from the display surface side.

[FIG. 4] A graph illustrating an example of a relationship between a second cumulative lighting time and a luminance reduction rate.

[FIG. 5] A graph illustrating an example of a relationship between a first cumulative lighting time and a luminance reduction rate.

[FIG. 6] A graph illustrating an example of a relationship between a first cumulative lighting time and a luminance reduction rate.

[FIG. 7] A graph illustrating an example of a relationship between a second cumulative lighting time and a luminance reduction rate.

[FIG. 8] A schematic plan view illustrating the second LED display unit of Modification of Embodiment 1 according to the present invention.

[FIG. 9] A block diagram illustrating a configuration of an LED display device of Embodiment 2 according to the present invention.

[FIG. 10] A schematic plan view of a second LED display unit of the LED display device of Embodiment 2 according to the present invention as viewed from the display surface side.

[FIG. 11] A schematic plan view illustrating the second LED display unit of Modification 1 of Embodiment 2 according to the present invention.

[FIG. 12] A schematic plan view illustrating the second LED display unit of Modification 2 of Embodiment 2 according to the present invention.

### DESCRIPTION OF EMBODIMENTS

A display device of Embodiment 4 according to the present invention will be described below. In each Embodiment, although an LED display device will be described as an example of the display device, the application of the present invention is not limited to the LED display device.

### Embodiment 1

<Configuration of Device>

FIG. 1 is a block diagram illustrating a configuration of an LED display device 100 of Embodiment 1 according to the present invention. As illustrated in FIG. 1, the LED display device 100 includes a first LED display unit 1, a second LED display unit 2, an input terminal 3, a video signal processing unit 4, a signal corrector 5, a first driver 6, a lighting time storage 7, a signal generation unit 8, a second driver 9, a light receiving unit 10, a luminance transition storage 11, and a correction coefficient calculator 12. The signal corrector 5 and the correction coefficient calculator 12 are included in the luminance corrector 18.

First, hardware that realizes the LED display device 100 will be described. LED display panels are applied to the first LED display unit 1 and the second LED display unit 2, for example, and a measurement device such as a photodiode capable of measuring at a wavelength in the visible range is applied to the light receiving unit 10, for example.

The memory 91 of FIG. 2 is applied to the lighting time storage 7 and the luminance transition storage 11, for example. The video signal processing unit 4, the signal corrector 5, the first driver 6, the signal generation unit 8, the second driver 9, and the correction coefficient calculator 12 (hereinafter may be referred to as “video signal processing unit 4 etc.”) are realized by executing the program stored in the memory 91 by a processor 92 of FIG. 2.

The memory 91 includes, a non-volatile or volatile semiconductor memory such as a RAM, a ROM, a flash memory, an EPROM, and an EEPROM, and a magnetic disk, a flexible disk, an optical disk, a compact disk, a mini disk, a DVD, and the like. The processor 92 includes, for example, a central processing unit (CPU), an arithmetic unit, a microprocessor, a microcomputer, a processor, and a Digital Signal Processor (DSP). The program causes a computer to execute a processing procedure and a processing method in the video signal processing unit 4 and the like, and is realized by, for example, software, firmware, or a combination of software and firmware.

The video signal processing unit 4 and the like are not limited to the configuration realized by operating according to the software program, and may be, for example, a signal processing circuit that realizes the operation by a hardware electric circuit. Alternatively, the video signal processing unit 4 and the like may be a combination of a configuration realized by a software program and a configuration realized by hardware.

First, each configuration in the LED display device 100 will be described. The first LED display unit 1 has a plurality of first LEDs 1a (first light emitting elements). In Embodiment 1, although an example in which a total of 16 first LEDs 1a of 4 by 4 matrix is illustrated, the number of first LEDs 1a is not limited thereto, and per unit of 1 million LEDs are arranged in an actual display device.

The first LED display unit 1 displays desired images such as characters and figures. The first LED display unit 1 is driven based on a first drive signal output from a first driver 6 described later. The first drive signal includes a display pattern, a drive pattern, and drive data. The first drive signal output from the first driver 6 controls the lighting of each first LED 1a.

The luminance of the first LED display unit 1 is set to two luminance levels such as high luminance and normal luminance, and setting high luminance (first luminance level) is a high luminance mode, and setting normal luminance (second luminance level) is a normal luminance mode. In each luminance mode, all LED drive current values for the plurality of first LEDs 1a are set to the same value, and the high luminance mode is set to have a larger LED drive current value than the normal luminance mode. In the following description, the plurality of first LEDs 1a are assumed to be lighting-controlled by the drive current value of the high luminance mode or the normal luminance mode. Although a first LED 1a includes an LED of any of red (R), green (G), and blue (B), in the following description, the difference in color is not particularly limited.

The second LED display unit 2 has a plurality of second LEDs 2a (second light emitting elements). FIG. 3 is a schematic plan view of the second LED display unit 2 as viewed from the display surface side. As illustrated in FIG. 3, in Embodiment 1, two second LEDs 2a are arranged at point symmetrical positions with respect to a point 101 that intersects with a center line 101 of the light receiving unit 10 described later. In FIG. 3, although the two second LEDs 2a are distinguished by the presence or absence of hatching, this does not specify the high luminance mode and the normal luminance mode, as this only schematically indicates different luminance modes.

The second LED display unit 2 is arranged on the back surface side of the circuit board on which the plurality of first LEDs 1a of the first LED display unit 1 are mounted or in the vicinity of the first LED display unit 1, so that the second LED display unit 2 is turned on under the same temperature environment as the first LED display unit 1, and the luminance reduction rates for the both become closer with each other.

The second LED display unit 2 is driven based on a second drive signal output from a second driver 9 described later. The second drive signal includes a display pattern, a drive pattern, and drive data. The second drive signal output from the second driver 9 controls the lighting of each second LED 2a.

The LED drive current values for the two second LEDs 2a are set to the same values as the LED drive currents in the high luminance mode or the normal luminance mode, which is the luminance setting of the first LEDs 1a. That is, the drive current values for the two second LEDs 2a are different from one another, one is in the high luminance mode, the other is in the normal luminance mode. The two second LEDs 2a are controlled in a manner that the luminance of respective rays emitted therefrom differs from each other. Although a second LED 2a includes an LED of any of red (R), green (G), and blue (B), in the following description, the difference in color is not particularly limited.

The second LED display unit 2 displays for the LED display device 100 to measure or predict the time transition of the luminance of the first LED display unit 1. Note that the time transition of the luminance is represented by, for example, the luminance maintenance rate indicating the current luminance with the initial luminance being 100%, or the luminance reduction rate (=100%-luminance maintenance rate) which has the inverse relationship to the luminance maintenance rate, or the like. The following description will be made assuming that the luminance reduction rate is applied to the luminance time transition.

If the LED drive current values are the same, the luminance reduction rate of each second LED 2a and the luminance reduction rate of each first LED 1a are equal. That is, the luminance reduction rate of each second LED 2a is the same as or similar enough to be identified as the luminance reduction rate of each first LED 1a. The reason for this is because the LEDs from the same production lot are applied for each first LED 1a and each second LED 2a, or the LEDs having the same BIN code categorizing LEDs based on the luminance and wavelength are applied for each first LED 1a and each second LED2a. Such first LEDs 1a and second LEDs 2a have similar characteristics such as luminance and wavelength, and if the LED drive current values are the same, the luminance reduction rates of the two are the same.

In addition, in Embodiment 1, the display operation of the first LED display unit 1, that is, the driving of the LED, and the display operation of the second LED display unit 2, that is, the driving of the LED, are performed in parallel. As a result, the first LEDs 1a and the second LEDs 2a are turned on under the same environment and the luminance reduction rates of the two can be brought closer to each other. The lighting control of the plurality of first LEDs 1a follows the image to be displayed on the first LED display unit 1; therefore, each first LED is not on for quite a while, and the cumulative lighting time of each first LED 1a differs from one another. On the other hand, the lighting control of the two second LEDs 2a does not follow the image to be displayed on the first LED display unit 1, and each second LED 2a is always on. Therefore, the cumulative lighting time of each second LED 2a is longer than any cumulative lighting time of the first LEDs 1a.

The input terminal 3 receives a video signal from the outside. The video signal processing unit 4 selects an area required for display based on the video signal received by the input terminal 3, and also performs processing such as gamma correction.

The signal corrector 5 corrects luminance information included in the output signal of the video signal processing unit 4 using the correction coefficient input from the correction coefficient calculator 12 described later. With this correction, the signal corrector 5 can practically correct not only the first drive signal output from the first driver 6 to the first LED display unit 1, but the luminance of one or more first LEDs 1a.

The first driver 6 generates the first drive signal for driving the first LED display unit 1, based on the output signal corrected by the signal corrector 5. The first driver 6 drives the first LED display section 1 by outputting the first drive signal to the first LED display section 1, that is, controls the lighting of each first LED 1a.

The lighting time storage 7 stores a first cumulative lighting time of each of the first LEDs 1a. The first cumulative lighting time is a time obtained by cumulatively adding the times when each first LED 1a is on.

The signal generation unit 8 generates a signal for generating a second drive signal of the second LED display unit based on the output signal corrected by the signal corrector 5.

The second driver 9 generates the second drive signal for driving the second LED display unit 2 based on the signal generated by the signal generation unit 8. The second driver 9 drives the second LED display section 2 by outputting the second drive signal to the second LED display section 2, that is, controls the lighting of each second LED 2a. As described above, in Embodiment 1, the second LED display unit 2 includes the two second LEDs 2a. The two second LEDs 2a have different LED drive current values, and lighting control is performed by the second driver 9. The two different LED drive current values are set to the same values as the LED drive currents in the high luminance mode or the normal luminance mode, which is the luminance setting of the first LEDs 1a described above.

The second driving unit 9 also includes a detection unit (not illustrated). The detection unit detects whether each second LED 2a included in the second LED display unit 2 is in a failure state or a normal state. Then, the detection unit counts the number of second LEDs 2a that are normally on. Noted that, when detected that one of the two second LEDs 2a is not normally on, the second driver 9 notifies the outside of the LED display device 100 of occurrence of malfunction in the second LED display unit 2.

The light receiving unit 10 is arranged to face the second LED display unit 2. The light receiving unit 10 receives rays emitted from the two second LEDs 2a and measures the luminance thereof. As described above, the lighting of the two second LEDs 2a is controlled with respectively different LED drive current values, and the luminance of rays emitted therefrom also respectively differs from each other. Therefore, the light receiving unit 10 alternately measures the luminance of the two second LEDs 2a. That is, the second LED 2a, which is not measured, is temporarily turned off by the lighting control of the second driving unit 9, and the light receiving unit 10 does not receive the ray. This is repeated alternately between the two second LEDs 2a, so that the light receiving unit 10 can alternately measure the luminance of the two second LEDs 2a.

As illustrated in FIG. 3, the two second LEDs 2a included in the second LED display unit 2 are arranged at point symmetrical positions about the point 101 intersecting with the center line 101 of the light receiving unit 10; therefore, the light receiving unit 10 can receive the rays emitted by the two second LEDs 2a under the same conditions except that the LED drive current values are different, and measure the luminance thereof. That is, measurement of the luminance of two different LED drive current values is ensured with one light receiving unit 10.

Further, as described above, LEDs from the same production lot or LEDs having the same BIN code categorizing LEDs based on the luminance or the like are applied for each first LED 1a and each second LED 2a. Therefore, the characteristics such as the luminance of each first LED 1a and each second LED 2a are substantially the same.

The luminance transition storage 11 associates the luminance of each second LED 2a measured by the light receiving unit 10 with the second cumulative lighting time of each second LED 2a and stores thereof. The second cumulative lighting time is a time obtained by cumulatively adding the times when each second LED 2a is on. As described above, the light receiving unit 10 measures the luminance of each of the two second LEDs 2a having different LED drive current values, respectively; therefore, the luminance transition storage 11 associates the luminance of each second LED 2a of two different conditions of the LED drive current values with the second cumulative lighting time of each second LED 2a, and stores thereof.

Although, each of the second LEDs 2a is always on with a different LED drive current value, the measurement by the light receiving unit 10 and the storage by the luminance transition storage 11 do not always need to be performed. A typical characteristic of an LED is that the luminance decreases along with the cumulative lighting time is gradual; therefore, even if the measurement by the light receiving unit 10 and the storage by the luminance transition storage 11 are performed at fixed time intervals, the measurement or forecasting the time transition of the luminance of each first LED 1a is operable with no difficulty. Therefore, control is executed in a manner that, during normal operation, the second LEDs 2a are simultaneously turned on with different LED drive current values, and at the time of the luminance measurement, only the second LED 2a that is on with one LED drive current value is turned on and the luminance is measured by the light receiving unit 10, and subsequently, only the second LED 2a that is on with the other LED drive current value is turned on, and the luminance measurement is measured.

In this case, when the light receiving unit 10 alternately measures the luminance of the two second LEDs 2a whose lighting is controlled with different LED drive current values, temporary turning off of the second LED 2a, which is not being measured, is readily performed by the lighting control of the second driver 9 by providing a certain time interval, and the luminance measurement period is shorter than that during normal operation; therefore, the passage of each 2nd cumulative lighting time is hardly affected.

The correction coefficient calculator 12 calculates the luminance reduction rate based on the first cumulative lighting time stored in the lighting time storage 7 and the luminance of the second LED 2a and the second cumulative lighting time stored in the luminance transition storage 11. Then, the correction coefficient calculator 12 calculates the correction coefficient of the luminance based on the calculated luminance reduction rate.

As described above, the luminance transition storage 11 associates the luminance of each second LED 2a controlled under the two conditions of different LED drive current values, that is, the LED drive current values in the high luminance mode and the normal luminance mode with each second cumulative lighting time, and stores thereof.

When the correction coefficient calculator 12 calculates the luminance reduction rate and the correction coefficient of the luminance, the calculation is performed based on the luminance of the second LED 2a having the same drive current value as the drive current value of each first LED 1a whose lighting is being controlled in the high luminance mode or the normal luminance mode.

Here, as illustrated in FIG. 1, the signal corrector 5 and the correction coefficient calculator 12 are included in the luminance corrector 18. The luminance corrector 18 calculates the above correction coefficient based on the first cumulative lighting time stored in the lighting time storage 7 and the luminance and the second cumulative lighting time of the second LED 2a having the same drive current value as the drive current value for controlling the lighting of each of the first LEDs 1a stored in the luminance transition storage 11. Then, the luminance corrector 18 uses the correction coefficient to correct the luminance information included in the output signal of the video signal processing unit 4. As a result, not only the first drive signal output from the first driver 6 to the first LED display unit 1, but the luminance of the first LED 1a is corrected.

Note that in Embodiment 1, as described above, the lighting control of the plurality of first LEDs 1a follows the image to be displayed on the first LED display unit 1; therefore, each first LED is not on for quite a while, and the cumulative lighting time of each first LED 1a differs from one another.

On the other hand, the lighting control of the two second LEDs 2a does not follow the image to be displayed on the first LED display unit 1, and each second LED 2a is always on. That is, the length of the second cumulative lighting time of the second LED 2a is controlled to be equal to or longer than the length of the first cumulative lighting time of the first LED 1a.

Further, by being driven based on the same second drive signal from the second drive section 9, the lighting control of each second LED 2a is performed in a similar manner even though the two second LEDs 2a have different drive current values. That is, the second cumulative lighting times of the two second LEDs 2a are the same without any difference. When displaying a personal computer-based image being almost a still image on the first LED display unit 1, the plurality of first cumulative lighting times of the plurality of first LEDs 1a are estimated to be approximately 30% or less of the second cumulative lighting times of the two second LEDs 2a that are always on.

Then, the luminance corrector 18 is configured to perform the above correction based on the longest first cumulative lighting time among the plurality of first cumulative lighting times stored in the lighting time storage 7 and the luminance reduction rate and the second cumulative lighting time of the second LED 2a based on the same driving current value as the driving current value that controls the lighting of each first LED 1a, stored in the luminance transition storage 11.

<Correction Operation>

Hereinafter, a luminance correction operation in the LED display device 100 will be described. First, a description will be given of the luminance correction operation for eliminating the luminance variation of the first LED display unit 1 during the operation of the LED display device 100.

<Correction Operation for Eliminating Luminance Variation in Display Unit>

The luminance transition storage 11 stores the luminance measured by the light receiving unit 10 and the second cumulative lighting time of the second LED 2a in association with each other. The correction coefficient calculator 12 of the luminance corrector 18 reads out the luminance and the second cumulative lighting time from the luminance transition storage 11 and calculates the luminance reduction rate. As described above, the light receiving unit 10 measures the luminance of each of the two second LEDs 2a having different LED drive current values: therefore, the correction coefficient calculator 12 of the luminance corrector 18 calculates the luminance reduction rates under the two conditions of different LED drive current values.

FIG. 4 illustrates an example of the relationship between the second cumulative lighting time and the luminance reduction rate in the two second LEDs 2a (time characteristics of the luminance reduction rate) using the luminance reduction rate calculated by the correction coefficient calculator 12. In FIG. 4, the horizontal axis represents the second cumulative lighting time (time) and the vertical axis represents the luminance reduction rate (%). The horizontal axis of FIG. 4 is logarithmic, and 1K represents 1000 hours.

As described above, the lighting of the two second LED 2a are controlled with the drive current values in the high luminance mode and the normal luminance mode, respectively, the luminance of the ray emitted by each second LED 2a is also different;

therefore, the relationship between the two second cumulative lighting times and the luminance reduction rate for each different luminance mode, that is, the characteristic NBM of the normal luminance mode and the characteristic HBM of the high luminance mode are obtained, as illustrated in FIG. 4.

As illustrated in FIG. 4, the luminance reduction rate of the second LED 2a increases as the lighting time increases. That is, the luminance of both the second LED 2a in the normal luminance mode and the second LED 2a in the high luminance mode decreases. As described above, the lighting of the second LED 2a is controlled with higher LED drive current value in the high luminance mode than in the normal luminance mode, and the thermal load due to the temperature rise is greater; therefore, the luminance reduction rate of the second LED 2a being on in the high luminance mode is greater.

Further, as described above, if the LED drive current value is the same value, each first LED 1a of the first LED display unit 1 has the characteristics in which the luminance reduction rate thereof is similar enough to be identified as the luminance reduction rate of each second LED 2a.

FIG. 5 illustrates an example of the relationship between the first cumulative lighting time and the luminance reduction rate in the first LEDs 1a (time characteristics of the luminance reduction rate) when the first LED display unit 1 has been always on in the high luminance mode from the start of operation of the LED display device 100. In FIG. 5, the horizontal axis represents the second cumulative lighting time (time) and the vertical axis represents the luminance reduction rate (%). The horizontal axis of FIG. 5 is logarithmic, and 1K represents 1000 hours. Although, as illustrated in FIG. 1, a total of 16 first LEDs 1a are arranged in the first LED display unit 1, for convenience of description, FIG. 5 illustrates the relationship between the first cumulative lighting time and the luminance reduction rate for three representative first LEDs 1a having different first cumulative lighting times, that is, the characteristic LTS when the lighting time is short, the characteristic LTL when the lighting time is long, and the characteristic LTM between short and long lighting times only are displayed.

As illustrated in FIG. 5, the luminance of each first LED 1a also decreases with the lighting time, similarly to the luminance of the second LED 2a. However, there are differences in the first cumulative lighting time of each of the plurality of first LEDs 1a and the respective luminance reduction rates are also different; therefore, if the luminance of each of the plurality of first LEDs 1a is not corrected, a luminance variation occurs in the display in the first LED display unit 1.

When entering the correction operation for eliminating this variation, the correction coefficient calculator 12 reads out, from the luminance transition storage 11, the luminance of the second LED 2a of a lighting time which is the same as the lighting time of the first LED 1a stored in the lighting time storage 7, or a lighting time corresponding to the lighting time close thereto. Then the correction coefficient calculator 12 calculates the luminance reduction rate. Here, the lighting of each first LED 1a is controlled by the drive current value in the high luminance mode; therefore, the luminance of the second LED 2a that is also controlled by the drive current value in the high luminance mode is read out, and the luminance reduction rate is calculated. The lighting time of the first LED 1a stored in the lighting time storage 7 indicates the lighting time of all the first LEDs 1a.

As described above, if the LED drive current values are the same, the luminance reduction rate of each second LED 2a and the luminance reduction rate of each first LED 1a are equal. Therefore, the LED display device 100 according to Embodiment 1 calculates the luminance reduction rate of each first LED 1a without actual measurement of the luminance of each first LED 1a, as long as the luminance of each second LED 2a is actually measured.

At this time, the correction coefficient calculator 12 obtains the largest luminance reduction rate among the plurality of luminance reduction rates of the plurality of first LEDs 1a calculated based on the actual measurement value of the luminance of the second LED 2a as the maximum luminance reduction rate. Further, the correction coefficient calculator 12 refers to the lighting time storage 7 and the luminance transition storage 11, and for all the first LEDs 1a of the first LED display unit 1, and obtains a correction coefficient for each first LED 1a based on a theoretical luminance reduction rate with respect to the first cumulative lighting time and the above maximum luminance reduction rate.

The luminance corrector 18 uses the correction coefficient for each of the first LED 1a obtained by the correction coefficient calculator 12 to correct the luminance information included in the output signal of the video signal processing unit 4. The first drive signal is practically corrected by the correction. More specifically, the LED display device 100 corrects the luminance of each of the plurality of first LEDs 1a so as to match the luminance of the first LED 1a having the maximum luminance reduction rate, as indicated by the arrows in FIG. 5. That is, in the example illustrated in FIG. 5, among the characteristic LTS, the characteristic LTM, and the characteristic LTL, the luminance of all the first LEDs 1a is corrected so as to match the luminance of the first LED 1a of 20% which is the maximum luminance reduction rate indicated by the characteristic LTL.

<Calculation Example of Correction Coefficient>

Hereinafter, a calculation method of the correction coefficient for the first LED 1a in the correction coefficient calculator 12 will be described. In the following, as described with reference to FIG. 5, correction coefficients are calculated for three representative first LEDs 1a having different first cumulative lighting times, in which S represents a first LED 1a of short correction time, L represents a first LED 1a of long correction time, and M represents a first LED 1a between S and L, and the maximum cumulative lighting times for the respective first LEDs 1a of S, M, and L is represented by tsmax, tmmax, and tlmax.

Further, the characteristic LTS, the characteristic LTM, and the characteristic LTL illustrated in FIG. 5 can be respectively expressed by the functions ks(t), km(t), and kl(t) of the lighting time t. The functions ks(t), km(t), and kl(t) are calculable as a relational expressing such as an approximation formula or interpolation formula by performing regression analysis on the luminance and the second cumulative lighting time of the second LED 2a stored in the luminance transition storage 11.

The luminance corrector 18 refers to the lighting time storage 7, and searches the respective maximum cumulative lighting times tsmax, tmmax, and tbma of the first LEDs 1a of S, M, and L from a point of time at which luminance correction is performed, for example, a point at which the LED display device 100 starts operation, or at a last correction time to a point at which a predetermined unit time (for example, 1000 hours) has passed.

Then, the luminance corrector 18 acquires, from the luminance transition storage 11, the luminance of the second LED 2a corresponding to the second cumulative lighting time that is the same as or close to the maximum cumulative lighting times tsmax, tmmax, and tsmax, and calculates the luminance reduction rate. The luminance reduction rate of the second LED 2a calculated here is the luminance reduction rate of the second LED 2a whose lighting is controlled by the drive current value in the high brightness mode. And, the luminance reduction rate of the second LED 2a is almost the same as ks(tsmax), km(tmmax), and kl(tlmax) in which the respective tsmax, tmmax, and tsmax are applied to the t of the functions ks(t), km(t), and kl(t) of the above-described luminance reduction rates. Therefore, in the following description, the calculated luminance reduction rates of the second LEDs 2a may be referred to as luminance reduction rates ks(tsmax), km(tmmax), and kl(tlmax) for convenience.

The luminance corrector 18 obtains the largest luminance reduction rate among the luminance reduction rates kr(trmax), kg(tgmax), and kb(tbmax) as the maximum luminance reduction rate krgb(tmax). That is, the luminance corrector 18 obtains the maximum luminance reduction rate kslm(tmax) represented by the following mathematical expression (1).

[Expression 1]

ksml(tmax)=MAX(ks(tsmax), km(tmmax), kl(tlmax)) (1)

Next, the luminance corrector 18 refers to the lighting time storage 7 and the luminance transition storage 11, and for all the first LEDs 1a of the first LED display unit 1, and obtains a correction coefficient for each first LED 1a based on a theoretical luminance reduction rate kslm(tmax) with respect to the cumulative lighting time t and the maximum luminance reduction rate.

Here, the current theoretical luminance of the first LED 1a of S, M, L are represented by Sp, Mp, and Lp, and the theoretical luminance reduction rates of the first LEDs 1a of S, M, L at the cumulative lighting time t are represented by ks(t.), km(t), and kl(t), and the maximum luminance reduction rate is represented by ksml(tmax), the corrected luminance of Scomp, Mcomp, and Lcomp of the first LEDs 1a of the S, M, and L are represented by the following mathematical expression (2). Note that, for the luminance reduction rates ks(t), km(t), and kl(t) of S, M, and L at the cumulative lighting time t, for example, the maximum luminance reduction rate obtained in the last correction is applied.

$$\begin{matrix}[ Expression 2 ] & \\ \begin{matrix}Scomp = Sp \times \frac{1}{( 1 - ks ( t ) )} \times ( 1 - ksml ( t max ) ) \\ Mcomp = Mp \times \frac{1}{( 1 - km ( t ) )} \times ( 1 - ksml ( t max ) ) \\ Lcomp = Lp \times \frac{1}{( 1 - kl ( t ) )} \times ( 1 - ksml ( t max ) )\end{matrix} \} & ( 2 )\end{matrix}$$

The luminance corrector 18 according to Embodiment 1 uses an expression obtained by removing Sp, Mp, and Lp from the expression on the right side of Expression (2) above as the expression for the correction coefficient to be obtained.

Noted that, the current theoretical luminance Sp, Mp, and Lp in the above Expression (2) is indicated by the following Expression (3) in which initial luminance of the first LEDs 1 a of S, M, and L are represented by S0, M0, and L0.

$$\begin{matrix}[ Expression 3 ] & \\ \begin{matrix}Sp = S 0 \times ( 1 - ks ( t ) ) \\ Mp = M 0 \times ( 1 - km ( t ) ) \\ Lp = L 0 \times ( 1 - kl ( t ) )\end{matrix} \} & ( 3 )\end{matrix}$$

By substituting Expression (3) into Expression (2), the corrected luminance Scomp, Mcomp, Lcomp of the first LEDs 1a of S, M, L is expressed by following Expression (4).

$$\begin{matrix}[ Expression 4 ] & \\ \begin{matrix}Scomp = S 0 \times ( 1 - ksml ( t max ) ) \\ Mcomp = M 0 \times ( 1 - ksml ( t max ) ) \\ Lcomp = L 0 \times ( 1 - ksml ( t max ) )\end{matrix} \} & ( 4 )\end{matrix}$$

As illustrated in the above Expression (4), the luminance Scomp, Mcomp, Lcomp is luminance in which the initial luminance S0, M0, and L0 of S, M, and L of the first LEDs 1a is uniformly corrected with the maximum luminance reduction rate ksml(tmax).

In the LED display device 100 of Embodiment 1, such luminance correction lowers the brightness the whole first LED display unit 1 after the luminance correction compare with that of before the luminance correction, however, the luminance of all the first LEDs 1a is made uniform to the luminance of the LED having the longest lighting time, that is, the luminance having the greatest luminance reduction rate. This ensures to maintain the uniformity of luminance and the white balance of the entire first LED display unit 1, and not only the luminance variation but the chromaticity variation can also be suppressed.

<Correction Operation When Switching Luminance Mode During Operation>

Next, a correction operation when switching the lighting control of each first LED 1a of the first LED display unit 1 from the high luminance mode to the drive current value of the normal luminance mode during the operation of the LED display device 100 will be described. When the first LED display unit 1 is turned on in the high luminance mode and the luminance is too high for the observer to see because of such a case where, for example, the installation location of the LED display device 100 used at an event or the like is moved from a bright venue to another dark venue, or the content displayed on the 1st LED display part 1 is changed from dark one to bright one, or the like, turning on in normal brightness mode is considered.

FIG. 6 is a graph illustrating an example of a relationship between a first cumulative lighting time and a luminance reduction rate of each first LED 1a, when the lighting control of each first LED 1a of the first LED display unit 1 is switched from the high luminance mode to the drive current value of the normal luminance mode from the point of time of the first cumulative lighting time illustrated FIG. 5. The horizontal axis and the vertical axis indicate the same as in FIG. 5. Although, as in the same with FIG. 5, for convenience of description, FIG. 6 illustrates the relationship between the first cumulative lighting time and the luminance reduction rate for three representative first LEDs 1a having different first cumulative lighting times (time characteristics of the luminance reduction rate), that is, the characteristic LTS when the lighting time is short, the characteristic LTL when the lighting time is long, and the characteristic LTM between short and long lighting times only are displayed.

As illustrated in FIG. 6, the luminance of each first LED 1a also decreases with the lighting time. However, the degree of progress of luminance reduction with the passage of the first cumulative lighting time, that is, the characteristics indicating the luminance reduction rate of each first LED 1a shifts from the characteristic HBM indicating the luminance reduction rate in the high luminance mode to the characteristic NBM indicating the luminance reduction rate in the normal luminance mode of the relationships between the second cumulative lighting times of the second LEDs 2a in the different luminance modes and the luminance reduction rates illustrated in FIG. 4.

However, even if the second cumulative lighting times are the same, the luminance reduction rates differ depending on the luminance modes; therefore. it will be different from the actual degree of progress of the brightness reduction of the first LED 1a even if the correction is performed by simply replacing the characteristic HBM indicating the luminance reduction rate in the high luminance mode after the same second cumulative lighting time has passed with the characteristic NBM indicating the luminance reduction rate in the normal luminance mode.

Therefore, the correction coefficient calculator 12 calculates the second cumulative lighting time in the normal mode with the same luminance reduction rate as in the high luminance mode immediately before switching the lighting control of the first LED display unit 1 to the normal brightness mode. For example, in FIG. 5 illustrating the relationship between the first cumulative lighting time and the luminance reduction rate of each first LED 1a in the case of lighting the first LED display unit 1 in the high luminance mode, the first cumulative lighting time of the first LED 1a indicating the characteristic LTL is 10K hours, and its maximum luminance reduction rate is 20%.

Here, an enlarged view of the region “X” in the vicinity where the luminance reduction rate is 20% in FIG. 4 illustrating the relationship between the second cumulative lighting time and the luminance reduction rate of the second LED 2a is illustrated in FIG. 7. As illustrated in FIG. 5, when the first LED display unit 1 is on in the high luminance mode, the maximum luminance reduction rate of the first LED 1a is 20%, and the first cumulative lighting time is 10K hours.

In FIG. 7, from the characteristic NBM indicating the luminance reduction rate in the normal luminance mode, the second cumulative lighting time which indicates that the luminance reduction rate is also 20% is 20K hours. Even if the high luminance mode is switched to the normal luminance mode, the luminance reduction rate for each luminance mode is approximately the same; therefore, after the first cumulative lighting time passes 10K hours, as illustrated in FIG. 7, the luminance reduction of the first LED 1a progresses along the characteristic NBM indicating the luminance reduction rate after the second cumulative lighting time of 20K hours in the normal luminance mode.

That is, when the first cumulative lighting time of the first LED 1a that is the maximum luminance reduction rate passes, for example, 10K hours in the high luminance mode, and then passes 100 hours after switching to the normal luminance mode, the first LED 1a is replaced with the characteristic after operating for 20K hours+100 hours in the normal luminance mode to correct the luminance of the first LED 1a. In FIG. 7, the characteristic after operating for 20K hours+100 hours in the normal luminance mode are illustrated as RP, and it is replaced with the characteristic RP at the portion of 10K hours of the high luminance mode characteristic HBM and 20% of the luminance reduction rate.

Similarly, for the characteristic LTS and the characteristic LTM illustrated in FIG. 5, the characteristic LTS and the characteristic LTM showing the relationship between the first cumulative lighting time and the luminance reduction rate of the first LED 1a illustrated in FIG. 6 are obtained by replacing with the characteristics in the normal luminance mode having the same luminance reduction rates from the point at which the high luminance mode is switching to the normal luminance mode in FIG. 4 illustrating the relationship between the second cumulative lighting time ant the luminance reduction rate of the second LED 2a.

Also in the relationship between the first cumulative lighting time and the luminance reduction rate of the first LED 1a illustrated in FIG.6, the correction coefficient calculator 12 obtains the largest luminance reduction rate among the plurality of luminance reduction rates of the plurality of first LEDs 1a calculated based on the actual measurement value of the luminance of the second LED 2a as the maximum luminance reduction rate. Further, the correction coefficient calculator 12 refers to the lighting time storage 7 and the luminance transition storage 11, and for all the first LEDs 1a of the first LED display unit 1, and obtains a correction coefficient for each first LED 1a based on a theoretical luminance reduction rate with respect to the first cumulative lighting time and the above maximum luminance reduction rate. The method of obtaining the correction coefficient is the same as the method described using Expressions (1) to (4) described above.

The luminance corrector 18 uses the correction coefficient for each of the first LED 1a to correct the luminance information included in the output signal of the video signal processing unit 4. The first drive signal is practically corrected by the correction. The LED display device 100 corrects the luminance of each of the plurality of first LEDs 1a as indicated by the arrows in FIG. 6. More specifically, the LED display device 100 corrects the luminance of each of the plurality of first LEDs 1a so as to match the luminance of the first LED 1a having the maximum luminance reduction rate, as indicated by the arrows in FIG. 6. That is, in the example illustrated in FIG. 6, among the characteristic LTS, the characteristic LTM, and the characteristic LTL, the luminance of all the first LEDs 1a is corrected so as to match the luminance indicated by the one dot chain line which is the maximum luminance reduction rate indicated by the characteristic LTL.

In a case where the luminance mode of the second LED 2a can only be set to the high luminance mode, switching of the light control of the first LED display unit 1 from the high luminance mode tot the normal luminance mode during the operation of the LED display device 100 causes calculation error in the cumulative lighting time of the first LED 1a after the switching of the mode; therefore, the accuracy of the luminance correction of the first LED 1a decreases, and the variation in luminance of the display of the first LED display unit 1 occurs.

Whereas, as in Embodiment 1, the two second LEDs 2a are respectively on in the high luminance mode and the normal luminance mode, and the cumulative lighting time and the reduction in luminance of the first LED display unit 1 are predicted by using the respective cumulative lighting times; therefore, even when the lighting control of the first LED display unit 1 is switched from the high luminance mode to the normal brightness mode, the first LED display unit 1 as a whole can maintain the luminance uniformity and the white balance, and variations in luminance and chromaticity can be suppressed.

<Modification>

As described above, When adjusting the luminance of the first LED display unit 1 in two different settings of the high luminance mode and the normal luminance mode, as illustrated in FIG. 3, the two second LEDs 2a are arranged in the second LED display unit 2 so as to surround the point 101 at point symmetric positions around the point 101 intersecting with the center line 101 of the light receiving unit 10, and the lighting control of the LED drive current values of the respective two second LEDs 2a in the high luminance mode and the normal luminance mode is performed.

Here, in a case where adjustment is performed with three different modes in which, as the luminance of the first LED display unit 1, a mode of lower luminance (third luminance level) than the normal luminance mode is set as, for example, an ecology mode in addition to the high brightness mode and the normal brightness mode, by arranging three second LEDs 2a in the second LED display section 2 as illustrated in FIG. 8, at point symmetrical positions with respect to a point 101 intersecting with the center line 101 of the light receiving section 10, and controlling the drive current value of each second LED 2a in the high luminance mode, the normal luminance mode, and the ecology mode, thereby, suppression of the variations in the luminance and chromaticity of the first LED display unit 1 in three different luminance modes is ensured with a single light-receiving element. In FIG. 8, although the three second LEDs 2a are distinguished by the types of hatching, this does not specify the high luminance mode, the normal luminance mode or the ecology mode, as this only schematically indicates different luminance modes.

Further, in the above described Embodiment 1, an example in which the lighting of the first LED display unit 1 is changed from the high luminance mode to the normal luminance mode during the operation of the LED display device 100 has been described. The change of the luminance mode is not limited thereto. For example, the same effect as the above-described effect can be obtained in the case where the mode is changed from the normal luminance mode to the high luminance mode during the operation of the LED display device 100, and further, in the case where the luminance mode is changed frequently in such a manner that the LED display device 100 is operated in the high luminance mode during the day time, and is operated in the normal luminance mode during the night time.

### Embodiment 2

FIG. 9 is a block diagram illustrating a configuration of an LED display device 200 of Embodiment 2 according to the present invention. It should be noted that, in FIG. 9, the same components as those of the LED display device 100 described with reference to FIG. 1 are denoted by the same reference numerals, and overlapping descriptions are omitted.

As illustrated in FIG. 9, the LED display device 200 has a configuration in which the LED display device 200 further includes an average luminance calculator 13 that receives the output of the light receiving unit 10 and calculates the average luminance of the second LED 2a, and the output of the average luminance calculator 13 is sent to the luminance transition storage 11 and a lighting detection result of the second LED 2a in the second driver 9 is used for the calculation of the average luminance in the average luminance calculator 13. In addition, the second LED display unit 2 has four second LEDs 2a.

FIG. 10 is a schematic plan view of the second LED display unit 2 as viewed from the display surface side. As illustrated in FIG. 10, in the second LED display unit 2 of the LED display device 200, the four second LEDs 2a are arranged, in a two rows by two columns layout, at point symmetrical positions around the point 101 intersecting with the center line 101 of the light receiving unit 10.

The driving current values of the four second LEDs 2a are grouped into one set of two second LEDs 2a arranged diagonally in which the second LEDs 2a of the one set have the same values as the LED drive current in the high luminance mode and the other set of two second LEDs 2a have the same values as the LED drive current in the normal luminance mode. That is, the drive current value of each second LED 2a is set to be different for each set, and the luminance is also set to be different for each set. In FIG. 10, although the four second LEDs 2a are distinguished by the presence or absence of hatching, this does not specify the high luminance mode and the normal luminance mode, as this only schematically indicates different luminance modes.

In addition, as in the same with Embodiment 1, in Embodiment 2, the display operation of the first LED display unit 1, that is, the driving of the LED, and the display operation of the second LED display unit 2, that is, the driving of the LED, are also performed in parallel. As a result, the first LEDs 1a and the second LEDs 2a are turned on under the same environment and the luminance reduction rates of the two can be brought closer to each other. The lighting control of the plurality of first LEDs 1a follows the image to be displayed on the first LED display unit 1; therefore, each first LED is not on for quite a while, and the cumulative lighting time of each first LED 1a differs from one another. On the other hand, the lighting control of the four second LEDs 2a does not follow the image to be displayed on the first LED display unit 1, and each second LED 2a is always on.

As described above, the lighting of the two second LEDs 2a of one set are controlled by different LED drive current values for each set, and the luminance is also different for each set; therefore, the light receiving unit 10 periodically measure the luminance of the two sets of the second LEDs 2a, alternately. That is, one set of the second LEDs 2a, which is not measured, is temporarily turned off by the lighting control of the second driving unit 9, and the light receiving unit 10 does not receive the ray. This is repeated alternately between the two sets of second LEDs 2a, so that the light receiving unit 10 can alternately measure the luminance of the two sets of the second LEDs 2a.

As illustrated in FIG. 10, the four second LEDs 2a included in the second LED display unit 2 are arranged at point symmetrical positions about the point 101 intersecting with the center line 101 of the light receiving unit 10; therefore, the light receiving unit 10 can receive the rays emitted by the four second LEDs 2a under the same conditions except that the LED drive current values are different, and measure the luminance thereof. Further, the two second LEDs 2a diagonally arranged are grouped into one set, and the lighting of the one set of the second LEDs 2a is controlled by the LED drive current value in the high luminance mode and the lighting of the other set is controlled by the LED drive current value in the normal luminance mode, thereby the luminance of the two different drive current values is measured with a single light receiving unit 10.

Further, as described earlier, LEDs from the same production lot or LEDs having the same BIN code categorizing LEDs based on the luminance or the like are applied for each first LED 1a and each second LED 2a. Therefore, the characteristics such as the luminance of each first LED 1a and each second LED 2a are substantially the same.

The average luminance calculator 13 calculates the average brightness for each set of the second LEDs 2a. The average luminance is calculated by dividing the luminance of each set of the second LEDs 2a of the one set by the number of the second LEDs 2a, that are normally on which are counted by the detection unit of the second driver 9, between the second LEDs 2a in the one set, Therefore, the luminance of an LED can be calculated as the average luminance as long as at least one of the second LEDs 2a is normally on. Noted that, in the case where neither of the two second LEDs 2a in one set are not normally on, the average luminance is not calculated because the light receiving unit 10 does not receive the ray, and the second driver 9 notifies the outside of the LED display device 200 of occurrence of malfunction in the second LED display unit 2.

The luminance transition storage 11 associates the average luminance for each set of the second LEDs 2a calculated in the average luminance calculator 13 with the second cumulative lighting time of each second LED 2a and stores thereof. As described above, the light receiving unit 10 measures the luminance of the two sets of the second LEDs 2a having different LED drive current values, respectively; therefore, the luminance transition storage 11 associates the average luminance for each set of the second LEDs 2a of two different conditions of the LED drive current values with the second cumulative lighting time of each second LED 2a, and stores thereof. The second cumulative lighting time of each second LED 2a does not differ between the two sets having different LED drive current values, and all of four second LEDs 2a have the same second cumulative lighting time.

Although, each of the second LEDs 2a is always on with a LED drive current value different from one set after another, the measurement by the light receiving unit 10, the calculation by the average luminance calculator 13, and the storage by the luminance transition storage 11 do not always need to be performed. A typical characteristic of an LED is that the luminance decreases along with the cumulative lighting time is gradual; therefore, even if the measurement by the light receiving unit 10, the calculation by the average luminance calculator 13, and the storage by the luminance transition storage 11 are performed at fixed time intervals, the measurement or forecasting the time transition of the luminance of each first LED 1a is operable with no difficulty

Therefore, control is executed in a manner that, during normal operation, each set of the second LEDs 2a is simultaneously turned on with different LED drive current values, and at the time of the luminance measurement, only the one set of the second LEDs 2a that is on with one LED drive current value is turned on and the luminance is measured by the light receiving unit 10, and subsequently, only the other set of the second LEDs 2a that is on with the other LED drive current value is turned on, and the luminance measurement is measured.

In this case, when the light receiving unit 10 alternately measures the luminance of each set of the two second LEDs 2a whose lighting is controlled with different LED drive current values, temporary turning off of the set of the second LEDs 2a, which are not being measured, is readily performed by the lighting control of the second driver 9 by providing a certain time interval, and the luminance measurement period is shorter than that during normal operation; therefore, the passage of each 2nd cumulative lighting time is hardly affected.

The measurement by the light receiving unit 10, the calculation by the average luminance calculator 13, and the storage by the luminance transition storage 11 are periodically performed continuously while at least one second LED 2a of each set is on among the four second LEDs 2a included in second LED display unit 2.

The other components of the LED display device 200 and their functions are the same as those of Embodiment 1 by replacing the respective luminance of the two second LEDs 2a measured by the light receiving unit 10 and stored in the luminance transition storage 11 described in Embodiment 1 with the respective average luminance of the second LEDs 2a for each set calculated by the average luminance calculator 13.

As illustrated in FIG. 9, the four second LEDs 2a included in the second LED display unit 2 are arranged, in a two rows by two columns layout, at point symmetrical positions around the point 101 intersecting with the center line 101 of the light receiving unit 10, and the two second LEDs 2a diagonally arranged are grouped into one set, and the lighting of the one set of the second LEDs 2a is controlled by the LED drive current value in the high luminance mode and the lighting of the other set is controlled by the LED drive current value in the normal luminance mode. Therefore, the ratio (contribution rate) of the two second LEDs 2a in each set having different luminance modes to the luminance measured by the light receiving unit 10 is substantially the same. That is, the luminance measured for each set is not strongly influenced by the characteristics of one second LED 2a of one of the two second LEDs 2a in the set. Therefore, the luminance measured in the light receiving unit 10 is a value based on the characteristics of the two second LEDs 2a in which the characteristics of each set are equally averaged, and the influence of the characteristic variation of each second LED 2a is suppressed.

Further, the LED display device 200 can continuously implement correction of the luminance of the first LED 1a even when one of the second LEDs 2a in one set is turned off due to an accidental failure or the like. This is because, as described above, the average luminance calculator 13 calculates the average luminance of the second LEDs 2a for each set in the normal state, and the correction coefficient calculator 12 calculates the luminance reduction rate and the correction coefficient from the average luminance. Therefore, the contribution rate of the two second LEDs 2a for each set having different luminance modes to the luminance measured by the light receiving unit 10 is substantially the same. Therefore, even if any of the second LEDs 2a of one of the two second LEDs is turned off, the average luminance of the second LED2a for each set calculated in the average luminance calculator 13 is not affected, and the LED display device 200 can continuously implement accurate correction of the luminance of the first LED 1a.

Conventionally, the uniform control of the luminance and chromaticity of the entire LED display surface has been difficult when there are large variations in the characteristics of the LEDs for luminance measurement and when a failure occurs. However, according to the LED display device 200 in Embodiment 2, the influence of the characteristic variations of the LEDs for the luminance measurement and the influence of the luminance reduction due to the failure are eliminated, and the stable and uniform control without deviation in the luminance and chromaticity of the entire LED display device is ensured.

<Modification 1>

In the LED display device 200 according to Embodiment 2 described above, although two second LEDs 2a in one set for each luminance mode, that is four second LEDs 2a in total, are arranged in the second LED display unit 2 at point symmetrical positions around the point 101 intersecting with the center line 101 of the light receiving unit 10, as illustrated in FIG. 10, the number and arrangement of the second LEDs 2a in the second LED display unit 2 are not limited thereto.

As illustrated in FIG. 11, the arrangement in which three second LEDs 2a in one set for each luminance mode, that is six second LEDs 2a in total, are alternately arranged so as to surround the point 101 at a point symmetric position around the point 101 intersecting with the center line 101 of the light receiving unit 10 and the lighting control of the LED drive current value for one set in the high luminance mode and in the normal luminance mode further suppress the influence of characteristic variation of each second LED 2a in one set; therefore, redundancy can be further achieved when the second LEDs 2a in one set fails. In FIG. 11, although the six second LEDs 2a are distinguished by the presence or absence of hatching, this does not specify the high luminance mode and the normal luminance mode, as this only schematically indicates different luminance modes.

<Modification 2>

Further, in the case of arranging a total of six second LEDs 2a in the second LED display unit 2 as illustrated in FIG. 11, and the luminance of the first LED display unit 1 is controlled by three different luminance modes including, in addition to the high luminance mode and the normal luminance mode, the ecology mode having lower luminance than that of the normal luminance mode, as illustrated in FIG. 12, the arrangement in which two second LEDs 2a in one set for each luminance mode, that is six second LEDs 2a in total, are alternately arranged so as to surround the point 101 at a point symmetric position around the point 101 intersecting with the center line 101 of the light receiving unit 10 and by controlling the lighting of the LED drive current value for one set in the high luminance mode, the normal luminance mode, and the ecology mode, the luminance variation and chromaticity variation of the first LED display unit 1 in three different luminance modes can be suppressed with a single light-receiving element. In FIG. 11, although the six second LEDs 2a are distinguished by the types of hatching, this does not specify the high luminance mode, the normal luminance mode or the ecology mode, as this only schematically indicates different luminance modes.

Although, in each Embodiment described above, the LED display device including the display unit in which the LEDs are arranged as the light emitting element is illustrated, the display device is not limited to the LED display device, as long as a display device including a display unit in which a plurality of light sources, which are light sources of natural light as a light element, for example, a solid light source or a light source formed by coating or vapor deposition and whose luminance can be controlled, are arranged is adopted, the same effects as the effects illustrated in each of the above-described Embodiments are exhibited.

Further, although in each Embodiment described above, a configuration is described in which the signal for the luminance corrector 18 to correct the luminance information, that is, the signal related to the lighting control of each of the plurality of light emitting elements is an output signal output from the video signal processing unit 4, Modification 2 is not limited thereto, and a configuration in which a signal related to the lighting control of each of the plurality of light emitting elements is provided from other than the video signal processing unit 4 may be adopted.

It should be noted that Embodiments of the present invention can be arbitrarily combined and can be appropriately modified or omitted without departing from the scope of the invention.

While the invention has been described in detail, the forgoing description is in all aspects illustrative and not restrictive. It is understood that numerous other modifications and variations can be devised without departing from the scope of the invention.

### EXPLANATION OF REFERENCE SIGNS

1 first LED display unit, 1a first LED, 2 second LED display unit, 2a second LED, 5 signal corrector, 6 first driver, 7 lighting time storage, 8 signal generation unit, 9 second driver, 10 light receiving unit, 11 luminance transition storage, 12 correction coefficient calculator, 13 average luminance calculator, 18 luminance corrector.

1. A display device comprising:
a first display unit having a plurality of first light emitting elements and configured to display an image;
a second display unit having a plurality of second light emitting elements whose time transition on luminance is equal to that of the plurality of first light emitting elements;
a lighting time storage configured to store respective first cumulative lighting times of the plurality of first light emitting elements;
a light receiving unit configured to measure luminance of the plurality of second light emitting elements;
a luminance transition storage configured to associate the luminance of the plurality of second light emitting elements measured by the light receiving unit with a second cumulative lighting time of the plurality of second light emitting elements and store thereof; and
a luminance corrector configured to correct luminance of the plurality of first light emitting elements based on the first cumulative lighting time stored in the lighting time storage and the luminance of the plurality of second light emitting elements and the second cumulative lighting time stored in the luminance transition storage, wherein
the plurality of first light emitting elements are controlled to be on based on the image to be displayed and are set to a plurality of luminance levels corresponding to respective drive current values by drive current values for controlling lighting being set to a plurality of values,
each at least one of the plurality of second light emitting elements is provided for each of the drive current values for setting the plurality of luminance levels of the plurality of first light emitting elements, each one of the second light emitting elements is controlled to be always on at the respective drive current values and, when measuring by the light receiving unit, each of the plurality of second light emitting elements are controlled to be temporarily off alternately, and the luminance of the second light emitting elements that are on are associated with the second cumulative lighting time at the moment and stored in the luminance transition storage, and
the luminance corrector is configured to read out the luminance at the second cumulative lighting time at a same drive current value as the drive current values for setting the luminance levels of the plurality of first light emitting elements corresponding to the first cumulative lighting time of each of the plurality of first light emitting elements stored in the lighting time storage from the luminance transition storage to calculate luminance reduction rates of the second light emitting elements, set the luminance reduction rates of the second light emitting elements as luminance reduction rates of the plurality of first light emitting elements, and correct the luminance of the plurality of respective first light emitting elements so as to match a greatest maximum luminance reduction rate among the luminance reduction rates of the plurality of first light emitting elements.

2. (canceled)

3. The display device according to claim 1, wherein
when the luminance level of the plurality of first light emitting elements is switched from a first luminance level to a second luminance level, the luminance corrector is configured to calculate the luminance reduction rates of the plurality of first light emitting elements after being switched to the second luminance level according to time characteristics of the luminance reduction rates at the second luminance level obtained based on the luminance of the second light emitting elements whose lighting is controlled by a drive current which sets the second luminance level and the second cumulative lighting time, and correct the luminance of the plurality of respective first light emitting elements so as to match a greatest maximum luminance reduction rate among the luminance reduction rates of the plurality of first light emitting elements.

4. The display device according to claim 3, wherein
when the luminance level of the plurality of first light emitting elements is switched from the first luminance level to the second luminance level, as the time characteristics of the luminance reduction rates at the second luminance level, time characteristics after the second cumulative lighting time indicating the luminance reduction rates of the same second light emitting elements as the maximum luminance reduction rate at a point when switched from the first luminance level to the second luminance level are used.

5. The display device according to claim 1, wherein each at least two of the plurality of second light emitting elements are provided for each of the drive current values for setting a plurality of luminance levels of the plurality of first light emitting elements, and
the display device further comprises an average luminance calculator configured to calculate average luminance by dividing the luminance measured by the light receiving unit by a number of the at least two second light emitting elements that are normally on and output it as the luminance of the plurality of second light emitting elements.

6. The display device according to claim 1, wherein the plurality of second light emitting elements are arranged at point symmetrical positions about a point intersecting with a center line of the light receiving unit.
